(19) United States
(12) Patent Application Publication
(10) Pub. No.: US 2026/0122279 A1
(43) Pub. Date: Apr. 30, 2026

(54) EDRAP In DASH based On ARI Track

(71) Applicant: Bytedance Inc., Los Angeles, CA (US)

(72) Inventor: Ye-Kui Wang, San Diego, CA (US)

(21) Appl. No.: 19/003,547

(22) Filed: Dec. 27, 2024

Related U.S. Application Data
(63) Continuation of application No. PCT/US2023/026361, filed on Jun. 27, 2023.
(60) Provisional application No. 63/367,306, filed on Jun. 29, 2022.

(51) Int. Cl. H04N 19/70; H04N 19/44

(52) U.S. Cl. CPC H04N 19/70; H04N 19/44

(57) ABSTRACT

A mechanism for processing video data is disclosed. An indication is determined in an Addressable Resource Index (ARI) track configuration box in an ARI track. The ARI track indexes a Common Media Application Format (CMAF) switching set. The indication indicates whether extended dependent random access point (EDRAP) samples are allowed to be present in one or more tracks of the CMAF switching set. A conversion is performed between a media data and a media data file based on the indication.

### CROSS-REFERENCE TO RELATED APPLICATIONS

This application is a continuation of International Patent Application No. PCT/US2023/026361, filed on Jun. 27, 2023, which claims the priority to and benefits of U.S. Provisional Application No. 63/367,306, filed on Jun. 29, 2022. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are allowed to be present in one or more tracks of the CMAF switching set; and performing a conversion between a media data and a media data file based on the indication.

A second aspect relates to a non-transitory computer-readable recording medium storing a bitstream of a video which is generated by a method performed by a video processing apparatus, wherein the method comprises: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are allowed to be present in one or more tracks of the CMAF switching set; and generating a bitstream based on the determining.

A third aspect relates to an apparatus for processing video data comprising: a processor; and a non-transitory memory with instructions thereon, wherein the instructions upon execution by the processor, cause the processor to perform any of the preceding aspects.

A fourth aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fifth aspect relates to a method for storing bitstream of a video comprising: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are allowed to be present in one or more tracks of the CMAF switching set; generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRA WINGS

For a more complete understanding of this disclosure, reference is now made to the following brief description, taken in connection with the accompanying drawings and detailed description, wherein like reference numerals represent like parts.

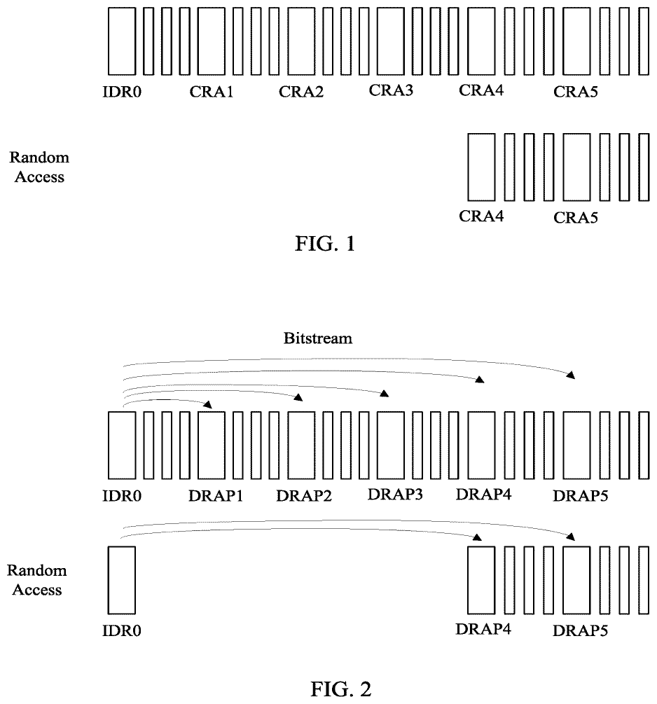

FIG. 1 is a schematic diagram of an example mechanism for random access when decoding a bitstream using intra random access points (IRAP) pictures.

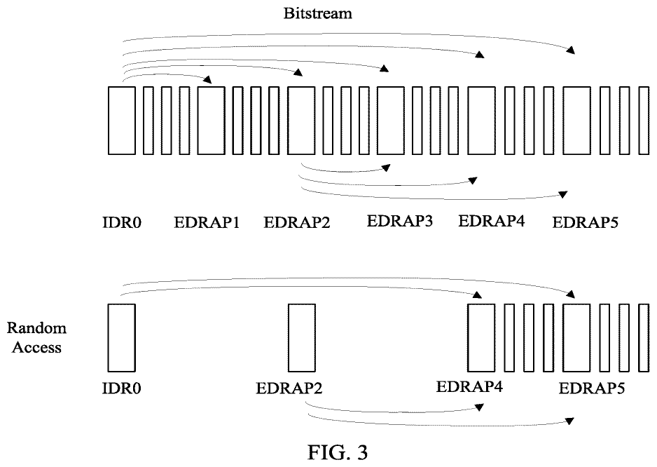

FIG. 2 is a schematic diagram of an example mechanism for random access when decoding a bitstream using dependent random access point (DRAP) pictures.

FIG. 3 is a schematic diagram of an example mechanism for random access when decoding a bitstream using EDRAP pictures.

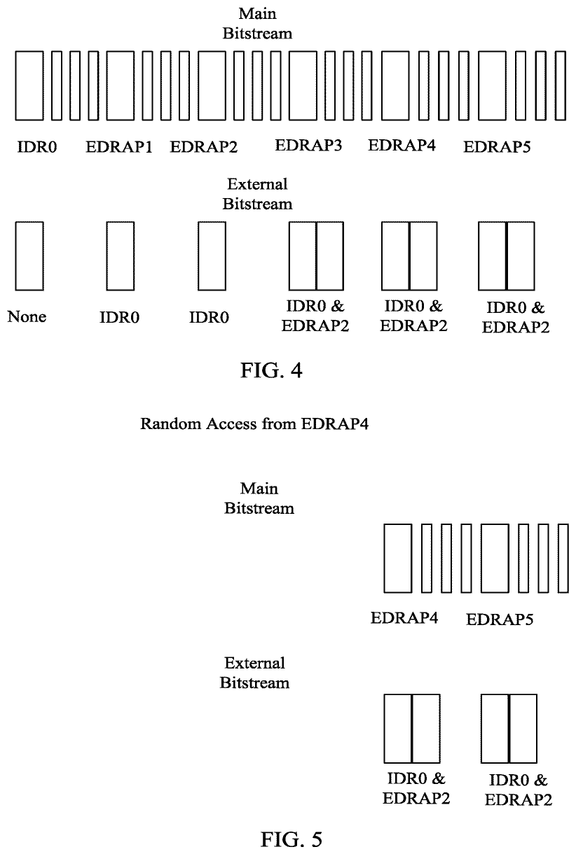

FIG. 4 is a schematic diagram of an example mechanism for signaling an external bitstream to support EDRAP based random access.

FIG. 5 illustrates an example of EDRAP based random access.

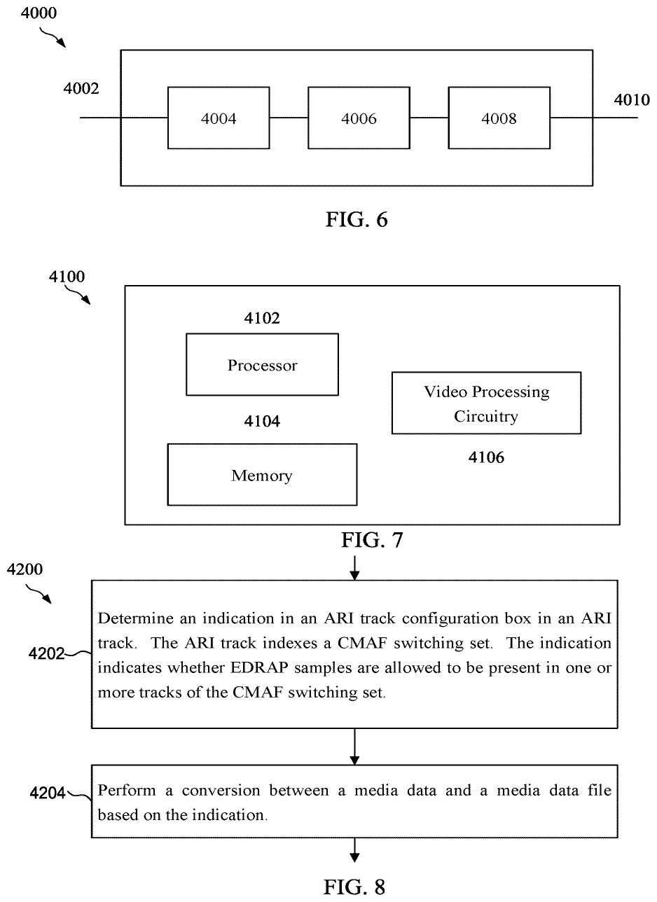

FIG. 6 is a block diagram showing an example video processing system.

FIG. 7 is a block diagram of an example video processing apparatus.

FIG. 8 is a flowchart for an example method of video processing.

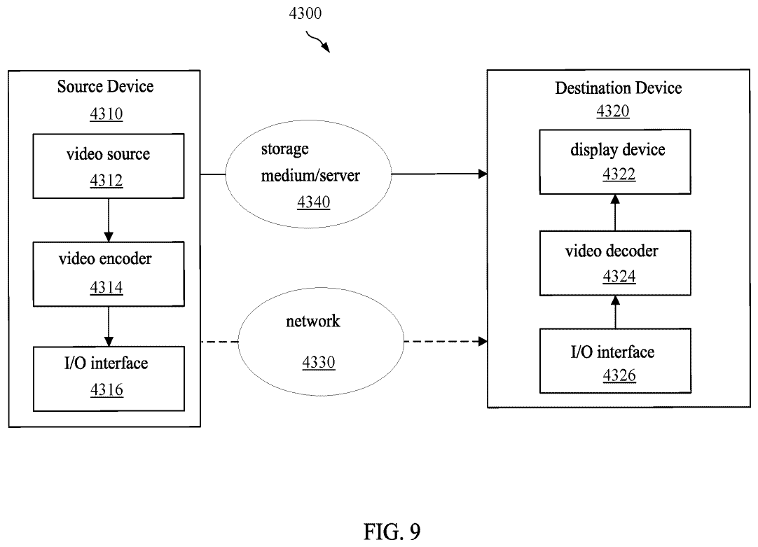

FIG. 9 is a block diagram that illustrates an example video coding system.

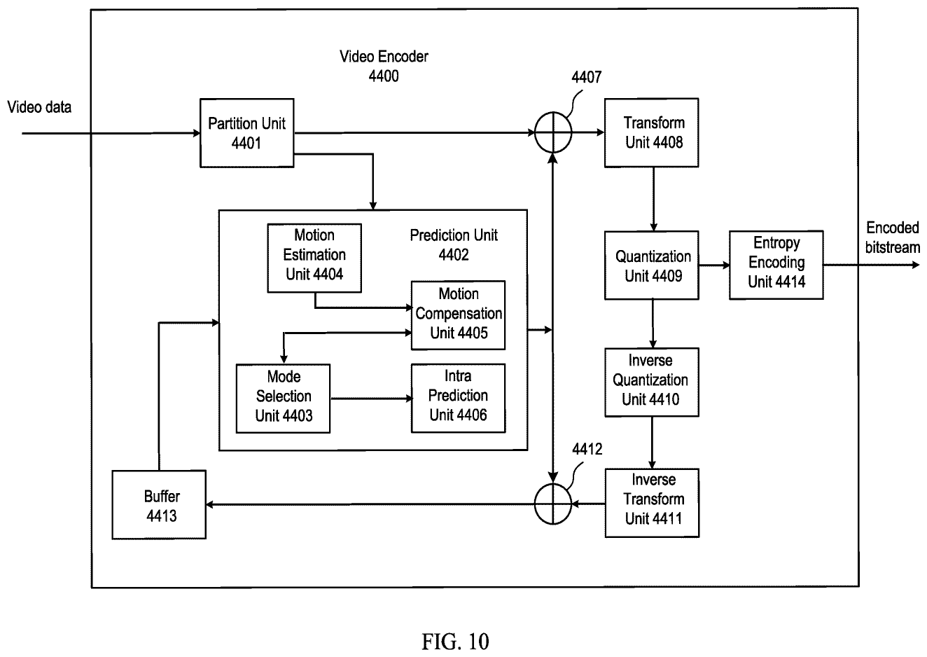

FIG. 10 is a block diagram that illustrates an example encoder.

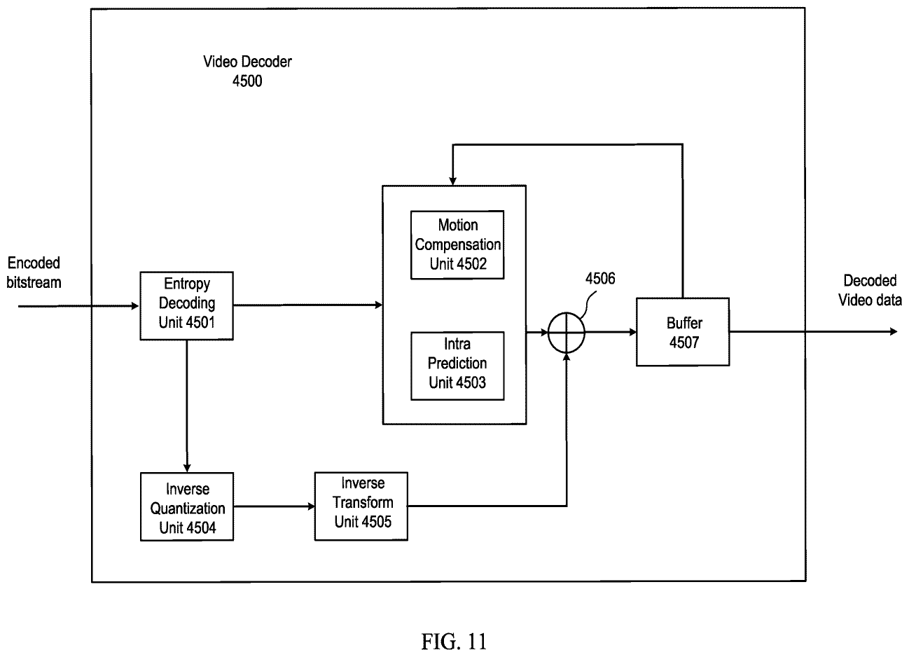

FIG. 11 is a block diagram that illustrates an example decoder.

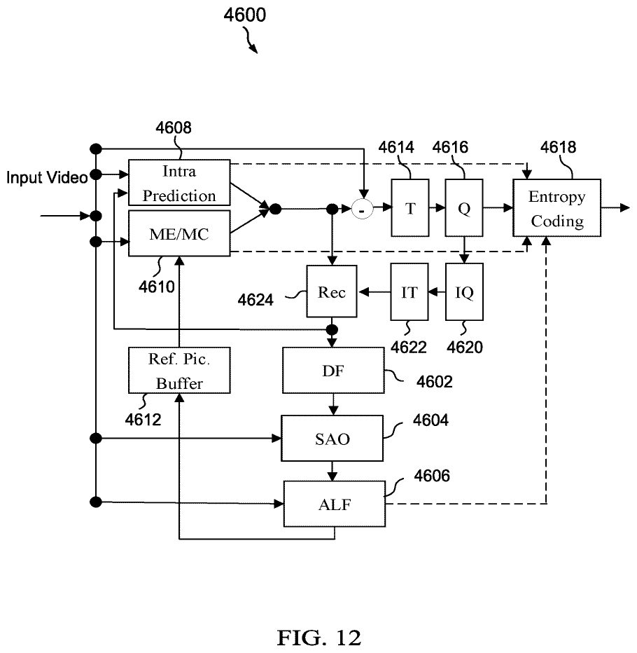

FIG. 12 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present document, editing changes are shown to text by bold italics indicating cancelled text and bold underline indicating added text, with respect to a draft of the Versatile Video Coding (VVC) specification or International Organization for Standardization (ISO) based media file format (ISOBMFF) file format specification.

### 1. INITIAL DISCUSSION

This document is related to video streaming. Specifically, this disclosure is related to the design of extended dependent random access point (EDRAP) based video streaming based on DASH, using Main Stream Representations (MSRs) and External Stream Representations (ESRs) as well as a signaling of EDRAP properties in an Addressable Resource Index (ARI) track. The examples may be applied individually or in various combinations, for media streaming systems, e.g., based on the Dynamic Adaptive Streaming over Hypertext Transfer Protocol (HTTP) (DASH) standard or its extensions, and/or the Common Media Application Format (CMAF).

### 2. VIDEO CODING INTRODUCTION

### 2.1 Video Coding Standards

Video coding standards have evolved primarily through the development of the International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by video coding experts group (VCEG) and MPEG jointly. Many methods have been adopted by JVET and put into the reference software named Joint Exploration Model (JEM) [2]. The JVET was renamed to be the Joint Video Experts Team (JVET) when the Versatile Video Coding (VVC) project officially started. VVC [3] is a coding standard, targeting at 50% bitrate reduction as compared to HEVC.

The Versatile Video Coding (VVC) standard (ITU-T H.266 | ISO/IEC 23090-3) [3][4] and the associated Versatile Supplemental Enhancement Information (VSEI) standard (ITU-T H.274 | ISO/IEC 23002-7) [5][6] is designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

### 2.2 File Format Standards

Media streaming applications are based on the internet protocol (IP), Transmission Control Protocol (TCP), and Hypertext Transfer Protocol (HTTP) transport methods, and rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format in [9], would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session.

Similarly, for using an image format with ISOBMFF, a file format specification specific to the image format, such as the AVC image file format and the HEVC image file format in [10], would be needed.

### 2.3 DASH

In Dynamic adaptive streaming over HTTP (DASH), there may be multiple representations for video and/or audio data of multimedia content. Different representations may correspond to different coding characteristics (e.g., different profiles or levels of a video coding standard, different bitrates, different spatial resolutions, etc.) The manifest of such representations may be defined in a Media Presentation Description (MPD) data structure. A media presentation may correspond to a structured collection of data that is accessible to a DASH streaming client device. The DASH streaming client device may request and download media data information to present a streaming service to a user of the client device. A media presentation may be described in the MPD data structure, which may include updates of the MPD.

A media presentation may contain a sequence of one or more periods. Each period may extend until the start of the next period or until the end of the media presentation in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, for example to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment may not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. In an example, the client device may select adaptation sets for certain types of media (e.g., video), and directly select representations for other types of media (e.g., audio and/or timed text). An example DASH streaming procedure is shown by the following steps. The client obtains the MPD. The client estimates the downlink bandwidth, and selects a video representation and an audio representation according to the estimated downlink bandwidth and the codec, decoding capability, display size, audio language setting, etc. Unless the end of the media presentation is reached, the client requests media segments of the selected representations and presents the streaming content to the user. The client continues to estimate the downlink bandwidth. When the bandwidth significantly changes in a direction (e.g., becomes lower), the client selects a different video representation to match the newly estimated bandwidth, and continues to download and display the media segments as at the updated representation.

### 2.4 Random Access and its Supports in HEVC and VVC

Random access refers to starting access and decoding of a bitstream from a picture that is not the first picture of the bitstream in decoding order. To support tuning in and channel switching in broadcast, multicast, and multiparty video conferencing, seeking in local playback and streaming, as well as stream adaptation in streaming, the bitstream should include frequent random-access points. Such random-access points may be intra coded pictures, but may also be inter-coded pictures, for example in the case of gradual decoding refresh.

HEVC includes signaling of intra random access points (IRAP) pictures in a NAL unit header through NAL unit types. Three types of IRAP pictures are supported in HEVC. These are instantaneous decoder refresh (IDR), clean random access (CRA), and broken link access (BLA) pictures. IDR pictures constrain the inter-picture prediction structure to not reference any picture before the current group-of-pictures (GOP). The reference pictures in the current GOP may be referred to as closed-GOP random access points. CRA pictures are less restrictive by allowing certain pictures to reference pictures before the current GOP, all of which are discarded in case of a random access. CRA pictures may be referred to as open-GOP random access points. BLA pictures usually originate from splicing of two bitstreams or part thereof at a CRA picture, for example during stream switching. To enable better systems usage of IRAP pictures, six different NAL units are defined to signal the properties of the IRAP pictures. Such properties can be used to better match the stream access point types as defined in the ISOBMFF [7], which are utilized for random access support in dynamic adaptive streaming over hypertext transfer protocol (DASH) [8].

VVC supports three types of IRAP pictures, two types of IDR pictures (one type with and the other type without associated random access decodable leading (RADL) pictures) and one type of CRA picture. These are used in a similar manner as in HEVC. The BLA picture types in HEVC are not included in VVC for two reasons. First, the basic functionality of BLA pictures can be realized by CRA pictures plus the end of sequence NAL unit, the presence of which indicates that the subsequent picture starts a new CVS in a single-layer bitstream. Second, there is a desire in specifying fewer NAL unit types than HEVC during the development of VVC, as indicated by the use of five instead of six bits for the NAL unit type field in the NAL unit header.

Another difference in random access support between VVC and HEVC is the support of gradual decoding refresh (GDR) in a more normative manner in VVC. In GDR, the decoding of a bitstream can start from an inter-coded picture. At the beginning of an access, the entire picture region can not be correctly decoded. However, after a number of pictures the entire picture region is correctly decoded. AVC and HEVC also support GDR by using a recovery point supplemental enhancement information (SEI) message for signaling of GDR random access points and recovery points. In VVC, a NAL unit type is specified for indication of GDR pictures and the recovery point is signaled in the picture header syntax structure. A coded video sequence (CVS) and a bitstream are allowed to start with a GDR picture. This means that an entire bitstream is allowed to contain only inter-coded pictures without a single intra-coded picture. The main benefit of specifying GDR support this way is to provide a conforming behavior for GDR. GDR enables encoders to smooth the bit rate of a bitstream by distributing intra-coded slices or blocks in multiple pictures as opposed to intra coding entire pictures. This allows significant end-to-end delay reduction, which is considered more important in many cases as ultralow delay applications like wireless display, online gaming, and drone-based applications become more popular.

Another GDR related feature in VVC is virtual boundary signaling. The boundary between the refreshed region, which is the correctly decoded region, and the unrefreshed region at a picture between a GDR picture and a corresponding recovery point can be signaled as a virtual boundary. When signaled, in-loop filtering across the boundary is not to be applied. Thus, a decoding mismatch for some samples at or near the boundary would not occur. This can be useful when the application determines to display the correctly decoded regions during the GDR process. IRAP pictures and GDR pictures can be collectively referred to as random access point (RAP) pictures.

### 2.5 Extended Dependent Random Access Point (EDRAP) Based Video Coding, Storage, and Streaming

### 2.5.1 the Concept and the Standard Support

The concept of EDRAP based video coding, storage, and streaming is described herein. As shown in FIG. 1, the application (e.g., adaptive streaming) determines the frequency of random access points (RAPs), e.g., RAP period 1s or 2s. In an example, RAPs are provided by coding of IRAP pictures. Note that inter prediction references for the non-key pictures between RAP pictures are not shown, and from left to right is the output order. When random accessing from CRA4, the decoder receives and correctly decodes CRA4, CRA5, etc. and related inter predicted pictures.

FIG. 2 illustrates the DRAP approach, which provides improved coding efficiency by allowing a DRAP picture (and subsequent pictures) to refer to the previous IRAP picture for inter prediction. Note that inter prediction for the non-key pictures between RAP pictures are not shown, and from left to right is the output order. When random accessing from DRAP4, the decoder receives and correctly decodes IDR0, DRAP4, DRAP5, etc. and related inter predicted pictures.

FIG. 3 illustrates the EDRAP approach, which provides a bit more flexibility by allowing an EDRAP picture (and subsequent pictures) to refer to a few of the earlier RAP pictures (IRAP or EDRAP). Note that inter prediction for the non-key pictures between RAP pictures are not shown, and from left to right is the output order. When random accessing from EDRAP4, the decoder receives and correctly decodes IDR0, EDRAP2, EDRAP4, EDRAP5, etc. and related inter predicted pictures.

FIG. 4 illustrates an example of the EDRAP approach using MSR segments and ESR segments. FIG. 5 illustrates an example of random access from EDRAP4. When random accessing from or switching to the segment starting at EDRAP4, the decoder receives and decodes segments including IDR0, EDRAP2, EDRAP4, EDRAP5, etc. and related inter predicted pictures.

EDRAP based video coding is supported by the EDRAP indication SEI message in an amendment to the VSEI standard. The storage part is supported by the EDRAP sample group and the associated external stream track reference in an amendment to the ISOBMFF standard. The streaming part is supported by the main stream representation (MSR) and external stream representation (ESR) descriptors included in an amendment to the DASH standard. These examples are described below.

### 2.5.2 the EDRAP Streaming in DASH

An example implementation of DASH includes the specification of the main stream Representation (MSR) and external stream Representation (ESR) descriptors, as follows:

### Change 1: EDRAP Streaming

In clause 2, add the following reference: ISO/IEC 14496-12:2021 AMD1, Information technology—Coding of audio-visual objects—Part 12: ISO base media file format, AMD 1 Improved brand documentation and other improvements

In subclause 3.2, add the following abbreviations: extended dependent random access point (EDRAP), external stream Representation (ESR), and main stream Representation (MSR).

Add subclause 5.8.5.15 as follows:

### 5.8.5.15 MSR and ESR Descriptors

### 5.8.5.15.1 General

An Adaptation Set may have an EssentialProperty descriptor with @schemeldUri equal to urn:mpeg:dash:msr:2022. This descriptor is referred to as the MSR descriptor. This descriptor may only be present in an Adaptation Set level and its presence indicates that each Representation in that Adaptation Set is an MSR, which carries a video track containing a track reference of type ‘aest’.

An Adaptation Set may have an EssentialProperty descriptor with @schemeIdUri equal to urn:mpeg:dash:esr:2022. This descriptor is referred to as the ESR descriptor. This descriptor may only be present in an Adaptation Set level and its presence indicates that each Representation in the Adaptation Set is an ESR, which carries a video track referenced by a track reference of type ‘aest’. An ESR is only intended to be consumed or played back together with its associated MSR.

Each ESR shall be associated with an MSR through the Representation-level attributes @associationId and @associationType in the MSR as follows: the @id of the associated ESR shall be referred to by a value contained in the attribute @associationId for which the corresponding value in the attribute @associationType is equal to ‘aest’. Each MSR shall have an associated ESR.

For an MSR and an ESR associated with each other, the following applies:

For each media sample with a particular presentation time in the ESR, there shall be a corresponding media sample with the same presentation time in the MSR. Each media sample in the MSR that has a corresponding ESR media sample is referred to as an EDRAP sample. The first byte position of each EDRAP sample in the MSR shall be the index of the starting access unit (ISAU) of a sequence access point (SAP), which enables playback of the media stream in the MSR provided that the corresponding ESR media sample is provided to the media decoder immediately before the EDRAP sample. Each EDRAP sample in the MSR shall be the first sample in a Segment or Subsegment (e.g., each EDRAP sample shall start a Segment or Subsegment). For each Segment or Subsegment in the MSR that starts with an EDRAP sample, there shall be a Segment in the ESR with the same earliest presentation time as the MSR Segment or Subsegment. This Segment in ESR is referred to as the corresponding ESR Segment of the MSR Segment or Subsegment and vice versa. The concatenation of any Segment in the ESR and the corresponding MSR Segment or Subsegment (e.g., the MSR Segment or Subsegment having the same earliest presentation time as the ESR Segment) and all subsequent MSR Segments or Subsegments shall result in a conforming bitstream. For each MSR Segment or Subsegment that does not start with an EDRAP sample, there shall be no corresponding ESR Segment having the same earliest presentation time as the MSR Segment or Subsegment.

### 5.8.5.15.2 Example Content Preparation and Client Operations (Informative)

Below are example content preparation and client operations based on MSRs and their associated ESRs. An example of content preparation operations is as follows. A video content is encoded into one or more representations, each of which is of a particular spatial resolution, temporal resolution, and quality. Each representation of the video content is represented by a pair of MSR and ESR associated with each other. The MSRs of the video content are included in one Adaptation Set. The ESRs of the video content are included in another Adaptation Set.

An example of client operations is as follows. A client gets the MPD of the Media Presentation, parses the MPD, selects an MSR. When initializing a session or performing seeking, the client determines the starting presentation time from which the content is to be consumed, requests Segments or Subsegments of the MSR, starting from the Segment or Subsegment starting with a SAP and containing the sample having presentation time equal to (or earlier than but close enough to) the determined starting presentation time. For requesting Subsegments in a Segment, a Segment Index is requested beforehand to obtain information of the Subsegments and partial HTTP GET requests are used. If in the associated ESR there is a Segment having the same earliest presentation time as the starting MSR Segment or Subsegment, that ESR Segment is also requested, preferably before requesting of the starting MSR Segment or Subsegment. Otherwise, no Segment of the associated ESR is requested. When switching to a different MSR, the client requests Segments or Subsegments of the switch-to MSR, starting from the first Segment or Subsegment having earliest presentation time greater than that of the last requested Segment or Subsegment of the switch-from MSR. If in the associated ESR there is a Segment having the same earliest presentation time as the starting Segment or Subsegment in the switch-to MSR, that ESR Segment is also requested, preferably before requesting of the starting Segment or Subsegment in the switch-to MSR. Otherwise, no Segment of the associated ESR is requested. When continuously requesting and consuming subsequent Segments or Subsegments of an MSR after session initialization, seeking, or stream switching, no Segment of the associated ESR needs to be requested, including when requesting any subsequent MSR Segment or Subsegment starting with an EDRAP sample.

As can be seen from the above example client operations, the client should calculate the earliest presentation times of the MSR Segments and Subsegments as well as of the ESR Segments to figure out whether an MSR Segment or Subsegment has an associated ESR Segment.

### 2.6 Addressable Resource Index (ARI) Track in DASH

An example DASH implementation specifies the ARI track, as follows.

### Annex X

### Addressable Resource Index Track

### A.1 High-Level Solution

The following aspects are observed. In several cases there is a desire that an adaptive streaming client has exact knowledge of the duration and size of addressable resources and possible a subset of those on the server. Addressable Resources are Track Files, Segments, or Chunks in the CMAF context, but apply equally to DASH or HTTP Live Streaming (HLS). For on-demand services, an exact map of this information may be provided by the Segment Index.

However, there are cases for which additional information on segment information may be beneficial for the client and possibly network operation, for which the Segment Index is not sufficient. Examples include: A solution is required for different operation modes: low-latency live, live, time-shifted, video on demand (VOD). The solution is expected to work for different target latency of the client. The client and network address to operate in different network conditions. The message also includes information on the content quality. NOTE: Even though this track uses CMAF terminology, this can be applied to DASH Adaptation Sets that are not conforming to CMAF.

The Addressable Resource Index (ARI) Track provides a solution to the above use cases by describing all details of the Addressable resources and sub-sets of a CMAF Switching Set in a metadata track. An ARI Track is applied to a CMAF Switching Set for which each CMAF Track has identical Segment, Fragment, and Chunk Structure in terms of duration.

The following principles apply. The ARI Track is time-aligned with the CMAF Switching Set. The ARI Track documents the properties of several or all tracks of the CMAF Switching Set. A Header information is defined for the metadata track. A sample of the ARI track is associated to each CMAF chunk. The sample contains detailed information of the time-aligned CMAF chunks in several or all CMAF Tracks of the CMAF Switching Set. Each sample of the ARI Track is a sync sample. Delivery and Segmentation of the track is independent of the Chunk/Segment Structure of the associated switching set.

### A.2 Definition: CMAF Addressable Resource Index

### A.2.1 Definition

Sample Entry Type: ‘cari’
Container: Sample Description Box (‘stsd’)
Mandatory: No
Quantity: 0 or 1

This metadata describes all details of the addressable resources and sub-sets of a CMAF Switching Set in a metadata track. It is assumed that for several or all Tracks in the CMAF Switching Sets the same Segment, Fragment and Chunk structure applies. Further, each of the CMAF tracks can be uniquely identified by a track_id.

The following principles are applied. The ARI Track is time-aligned with the tracks of the CMAF Switching Set. The ARI Track documents the properties of all tracks of the CMAF Switching Set. A Header information is defined for the metadata track. A sample of the track is defined for each CMAF chunk in a time-aligned manner. The association of the chunk and the metadata sample is done such that the baseMediaDecodeTime of the chunk is identical to the sample time in the metadata track. The sample contains detailed information for the chunk in each of the tracks in the switching set. Note that this track may even be used to carry for example Events or Producer Reference time for the Media Presentation.

### A.2.2 Syntax

CMAF Addressable Resource Index Metadata use the following sample entry:

```
class CmafAriMetaDataSampleEntry( )
    extends MetaDataSampleEntry (‘cari’) {
  CmafAriConfigurationBox( );
}
aligned(8) class CmafAriConfigurationBox
  extends FullBox(‘cari’, version = 0, flags = 0) {
    unsigned int(32) switching_set_identifier;
    unsigned int(16) num_tracks;
  unsigned int(16) num_quality_indicators;
  for(i=1; i <= num_tracks; i++) {
      unsigned int(32) track_id;
      // provides the order of the tracks for each sample
  }
// additional information on the CMAF Switching Set may be provided
  for(i=1; i <= num_quality_indicators; i++) {
    string quality_identifier;
    }
  }
```

CMAF Addressable Resource Index samples use the following syntax:

class CmafAriFormatStruct ( ) {

for(i=1; i <= num_tracks; i++) {

// this information may also be provided per track

| | |
|---|---|
| unsigned int(1) | segment_start_flag; |
| unsigned int(1) | marker; |
| unsigned int(3) | SAP_type; |
| unsigned int(1) | emsg_flag; |
| unsigned int(1) | prft_flag; |
| bit(25) | reserved; |

```
      unsigned int(32) offset
      unsigned int(32) size;
      for(i=1; i <= num_quality_indicators; i++) {
```

unsigned int(32) quality;

```
    }
      unsigned int(1) loss;
      bit(15) reserved;
      unsigned int(8) num_prediction_pairs;
```

```
  for(i=1; i <= num_prediction_pairs; i++) {
    unsigned int(32) prediction_min_window;
    unsigned int(32) predicted_max_bitrate;
  }
```

### A.2.3 Semantics

switching_set_identifier specifies a unique identifier for the switching set in the context of the application. num_tracks indicates the number of tracks indexed in the ARI track. track_ID provides the selection and ordering in the samples of the tracks using the track_IDs. num_quality_indicators specifies the number of quality indicators used for identifying the quality of the chunk. quality_identifier specifies an identifier that tells how the quality values in the sample are expected to be interpreted. This is a four character code (4CC) code that can be registered. segment_start_flag indicates whether the chunk is the start of a segment. marker identifies if this chunk includes at least one styp box. SAP_type identifies the SAP type of the chunk. emsg_flag indicates whether this chunk provides at least one emsg box. prft_flag indicates whether this chunk includes at least one prft box. offset identifies the offset of the chunk from the start of the segment. size provides the size in octets of the chunk. quality provides the quality of the chunk according to a given quality scheme identifier. The data type of the quality value (integer or float) is defined by the quality scheme. If the quality scheme identifier is a null string, then quality is an unsigned integer, interpreted linearly with quality increase with increasing value. loss indicates that the media data of the chunk is lost. num_prediction_pairs provides how many pairs of the expected prediction values are provided. prediction_min_windows provides a value for minbuffer time identical to the MPD value. predicted_max_bitrate provides a value for bandwidth identical to the MPD semantics that holds for the duration of the prediction_min_windows value.

### 3. TECHNICAL PROBLEMS SOLVED BY DISCLOSED TECHNICAL SOLUTIONS

An example design for EDRAP based streaming and the design of ARI tracks have the following problems. In the configuration box of the ARI track that signals information for a CMAF switching set, it would be desirable to signal whether EDRAP samples may be present in one or more of the tracks of the CMAF switching set indexed in the ARI track. As can be seen from the example client operations in EDRAP streaming in DASH, the client should calculate the earliest presentation times of the MSR Segments and Subsegments as well as of the ESR Segments to figure out whether an MSR Segment or Subsegment has an associated ESR Segment. It would be desirable to signal whether an MSR Segment or Subsegment has an associated ESR Segment, thus avoiding the need of figuring the information out through calculating the earliest presentation times of the MSR Segments and Subsegments as well as of the ESR Segments.

### 4. A LISTING OF SOLUTIONS AND EMBODIMENTS

To solve the above-described problem, methods as summarized below are disclosed. The examples should be considered as examples to explain the general concepts and should not be interpreted in a narrow way. Furthermore, these examples can be applied individually or combined in any manner.

### Example 1

In one example, to solve the first problem, whether EDRAP samples may be present in one or more of the tracks of the CMAF switching set indexed in the ARI track is signaled in the ARI track configuration box.

### Example 2

In one example, to solve the second problem, whether an MSR Segment or Subsegment has an associated ESR Segment is signaled. In one example, whether an MSR Segment or Subsegment has an associated ESR Segment is signaled through an indication for an indexed track in a sample of an ARI track. The indication indicates whether the SAP that the chunk in the indexed track starts with is an EDRAP. Note that if an index track has an EDRAP sample, then that index track is an MSR. With the other constraints on EDRAP samples in an MSR in place, this indication of whether the SAP that the chunk in the indexed track starts with is an EDRAP indicates whether an MSR Segment or Subsegment has an associated ESR Segment. In another example, whether an MSR Segment or Subsegment has an associated ESR Segment is signaled in MPD.

### 5. EMBODIMENTS

Below are some example embodiments for some of the disclosure items summarized above in section 4. Most relevant parts that have been added or modified are shown in bold font, and some of the deleted parts are shown in italicized bold fonts. There may be some other changes that are editorial in nature and thus not highlighted.

### 5.1 First Embodiment

This embodiment is for items 1 and 2 above.

### Annex X

### Addressable Resource Index Track

### A.1 High-Level Solution

The following aspects are observed. In several cases there is a desire that an adaptive streaming client has exact knowledge of the duration and size of addressable resources and possible a subset of those on the server. Addressable Resources are Track Files, Segments, or Chunks in the CMAF context, but apply equally to DASH or HTTP Live Streaming (HLS). For on-demand services, an exact map of this information may be provided by the Segment Index.

However, there are cases for which additional information on segment information may be beneficial for the client and possibly network operation, for which the Segment Index is not sufficient. Examples include: A solution is required for different operation modes: low-latency live, live, time-shifted, VoD. The solution is expected to work for different target latency of the client. The client and network address to operate in different network conditions. The message also includes information on the content quality. NOTE: Even though this track uses CMAF terminology, this can be applied to DASH Adaptation Sets that are not conforming to CMAF.

The Addressable Resource Index (ARI) Track provides a solution to the above use cases by describing all details of the Addressable resources and sub-sets of a CMAF Switching Set in a metadata track. An ARI Track is applied to a CMAF Switching Set for which each CMAF Track has identical Segment, Fragment, and Chunk Structure in terms of duration.

The following principles apply. The ARI Track is time-aligned with the CMAF Switching Set. The ARI Track documents the properties of several or all tracks of the CMAF Switching Set. A Header information is defined for the metadata track. A sample of the ARI track is associated to each CMAF chunk. The sample contains detailed information of the time-aligned CMAF chunks in several or all CMAF Tracks of the CMAF Switching Set. Each sample of the ARI Track is a sync sample. Delivery and Segmentation of the track is independent of the Chunk/Segment Structure of the associated switching set.

### A.2 Definition: CMAF Addressable Resource Index

### A.2.1 Definition

Sample Entry Type: ‘cari’
Container: Sample Description Box (‘stsd’)
Mandatory: No
Quantity: 0 or 1

This metadata describes all details of the addressable resources and sub-sets of a CMAF Switching Set in a metadata track. It is assumed that for several or all Tracks in the CMAF Switching Sets the same Segment, Fragment and Chunk structure applies. Further, each of the CMAF tracks can be uniquely identified by a track_id.

The following principles are applied. The ARI Track is time-aligned with the tracks of the CMAF Switching Set. The ARI Track documents the properties of all tracks of the CMAF Switching Set. A Header information is defined for the metadata track. A sample of the track is defined for each CMAF chunk in a time-aligned manner. The association of the chunk and the metadata sample is done such that the baseMediaDecode Time of the chunk is identical to the sample time in the metadata track. The sample contains detailed information for the chunk in each of the tracks in the switching set. Note that this track may even be used to carry for example Events or Producer Reference time for the Media Presentation.

### A.2.2 Syntax

CMAF Addressable Resource Index Metadata use the following sample entry:

```
class CmafAriMetaDataSampleEntry( )
    extends MetaDataSampleEntry (‘cari’) {
  CmafAriConfigurationBox( );
}
aligned(8) class CmafAriConfigurationBox
    extends FullBox(‘cari’, version = 0, flags = 0) {
  unsigned int(32) switching_set_identifier;
  unsigned int(16 10) num_tracks;
  unsigned int(16 10) num_quality_indicators;
  unsigned int(1) edrap_{—}allowed_{—}flag;
  bit(11) reserved;
  for(i=1; i <= num_tracks; i++) {
      unsigned int(32) track_id;
      // provides the order of the tracks for each sample
}
// additional information on the CMAF Switching Set may be provided
for(i=1; i <= num_quality_indicators; i++) {
    string quality_identifier;
    }
  }
```

CMAF Addressable Resource Index samples use the following syntax:

```
class CmafAriFormatStruct ( ) {
          for(i=1; i <= num_tracks; i++) {
  // this information may also be provided per track
```

| | |
|---|---|
| unsigned int(1) | segment_start_flag; |
| unsigned int(1) | marker; |
| unsigned int(3) | SAP_type; |
| unsigned int(1) | emsg_flag; |
| unsigned int(1) | prft_flag; |
| unsigned int(1) | sap_{—}is_{—}edrap_{—}flag; |
| bit(25 24) | reserved; |
| unsigned int(32) | offset |
| unsigned int(32) | size; |

```
      for(i=1; i <= num_quality_indicators; i++) {
        unsigned int(32) quality;
    }
      unsigned int(1) loss;
      bit(15) reserved;
      unsigned int(8) num_prediction_pairs;
      for(i=1; i <= num_prediction_pairs; i++) {
```

| | |
|---|---|
| unsigned int(32) | prediction_min_window; |
| unsigned int(32) | predicted_max_bitrate; |

}
}

### A.2.3 Semantics

switching_set_identifier specifies a unique identifier for the switching set in the context of the application. num_tracks indicates the number of tracks indexed in the ARI track. num_quality_indicators specifies the number of quality indicators used for identifying the quality of the chunk.

edrap_allowed_flag specifies whether extended dependent random access point (EDRAP) samples may be present in one or more of the tracks indexed in the ARI track. An EDRAP sample is a sample for which all subsequent samples in the same track in both decoding and output order can be correctly decoded provided that the closest preceding SAP sample of type 1, 2, or 3 and zero or more preceding EDRAP samples are available when decoding the sample and the subsequent samples.

track_ID provides the selection and ordering in the samples of the tracks using the track_IDs. quality_identifier specifies an identifier that tells how the quality values in the sample are expected to be interpreted. This is a 4CC code that can be registered. segment_start_flag indicates whether the chunk is the start of a segment. marker identifies if this chunk includes at least one styp box.

SAP_type, when greater than 0, identifies the SAP type of the SAP this chunk starts with. emsg_flag indicates whether this chunk provides at least one emsg box. prft_flag indicates whether this chunk includes at least one prft box.

sap_is_edrap_flag indicates whether the SAP this chunk starts with is an EDRAP. When edrap_allowed_flag equal to 0, the value of sap_is_edrap_flag shall be equal to 0.

offset identifies the offset of the chunk from the start of the segment. size provides the size in octets of the chunk. quality provides the quality of the chunk according to a given quality scheme identifier. The data type of the quality value (integer or float) is defined by the quality scheme. If the quality scheme identifier is a null string, then quality is an unsigned integer, interpreted linearly with quality increase with increasing value. loss indicates that the media data of the chunk is lost. num_prediction_pairs provides how many pairs of the expected prediction values are provided. prediction_min_windows provides a value for minbuffer time identical to the MPD value. predicted_max_bitrate provides a value for bandwidth identical to the MPD semantics that holds for the duration of the prediction_min_windows value.
. . .

### 7. REFERENCES

[1] ITU-T and ISO/IEC. “High efficiency video coding”. Rec. ITU-T H.265 | ISO/IEC 23008-2 (in force edition).
[2] J. Chen, E. Alshina, G. J. Sullivan, J.-R. Ohm. J. Boyce. “Algorithm description of Joint Exploration Test Model 7 (JEM7).” JVET-G1001, August 2017.
[3] Rec. ITU-T H.266 | ISO/IEC 23090-3. “Versatile Video Coding”. 2020.
[4] B. Bross, J. Chen, S. Liu, Y.-K. Wang (editors). “Versatile Video Coding (Draft 10).” JVET-S2001.
[5] Rec. ITU-T Rec. H.274 | ISO/IEC 23002-7, “Versatile Supplemental Enhancement Information Messages for Coded Video Bitstreams”, 2020.
[6] J. Boyce, V. Drugeon, G. J. Sullivan, Y.-K. Wang (editors), “Versatile supplemental enhancement information messages for coded video bitstreams (Draft 5),” JVET-S2007.
[7] ISO/IEC 14496-12: “Information technology—Coding of audio-visual objects—Part 12: ISO base media file format”.
[8] ISO/IEC 23009-1: “Information technology—Dynamic adaptive streaming over HTTP (DASH)—Part 1: Media presentation description and segment formats”.
[9] ISO/IEC 14496-15: “Information technology—Coding of audio-visual objects—Part 15: Carriage of network abstraction layer (NAL) unit structured video in the ISO base media file format”.
[10] ISO/IEC 23008-12: “Information technology—High efficiency coding and media delivery in heterogeneous environments—Part 12: Image File Format”.
[11] J. Boyce, G. J. Sullivan, Y.-K. Wang (editors), “Additional SEI messages for VSEI (Draft 6),” JVET-Y2006.
[12] ISO/IEC JTC 1/SC 29/WG 03 output document N0550, “Potential Improvements of Text of CDAM ISO/IEC 14496-12:2021 AMD 1 Improved brand documentation and other improvements”, April 2022.
[13] ISO/IEC JTC 1/SC 29/WG 03 output document N0559, “WD of ISO/IEC 23009-1 5th edition AMD 2 EDRAP streaming and other extensions”, April 2022.
[14] ISO/IEC JTC 1/SC 29/WG 03 output document N0541, “Potential Improvements of ISO/IEC 23009-1 4th edition DAM 2 PrePeriod, nonlinear playback and other extensions”, April 2022.

FIG. 6 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 7 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 8 is a flowchart for an example method 4200 of video processing. The method 4200 determining an indication in an ARI track configuration box in an ARI track at step 4202. The ARI track indexes a CMAF switching set. The indication indicates whether EDRAP samples are allowed to be present in one or more tracks of the CMAF switching set. A conversion is performed between a media data and the media data file based on the indication at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

FIG. 9 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVM) standard and other current and/or further standards.

FIG. 10 is a block diagram illustrating an example of video encoder 4400, which may be video encoder 4314 in the system 4300 illustrated in FIG. 9. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

FIG. 11 is a block diagram illustrating an example of video decoder 4500 which may be video decoder 4324 in the system 4300 illustrated in FIG. 9. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

FIG. 12 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.

The following solutions show example embodiments of techniques discussed in the previous section (e.g., item 1).

1. A method for processing media data comprising: determining (4202) an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are present in one or more tracks of the CMAF switching set; and performing (4204) a conversion between a media data and a media data file based on the indication.

The following solutions show example embodiments of techniques discussed in the previous section (e.g., item 2).

2. A method for processing video data comprising: determining an indication indicating whether a main stream representation (MSR) segment or an MSR subsegment is associated with an external stream representation (ESR) segment; and performing a conversion between a media data and the media data file based on the indication.

3. The method of any of solutions 1-2, wherein the indication is included in an indication for an indexed track in a sample of an ARI track.

4. The method of any of solutions 1-3, wherein the indication indicates whether a sequence access point (SAP) at a beginning of a chunk in an indexed track is an EDRAP.

5. The method of any of solutions 1-4, wherein an indexed track contains an MSR when the indexed track contains an EDRAP sample.

6. The method of any of solutions 1-5, wherein the indication is in an Addressable Resource Index (ARI) track.

7. The method of any of solutions 1-5, wherein the indication is in a dynamic adaptive streaming over hypertext transfer protocol (DASH) media presentation description (MPD).

8. An apparatus for processing video data comprising: a processor; and a non-transitory memory with instructions thereon, wherein the instructions upon execution by the processor, cause the processor to perform the method of any of solutions 1-7.

9. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-7.

10. A non-transitory computer-readable recording medium storing a bitstream of a video which is generated by a method performed by a video processing apparatus, wherein the method comprises: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are present in one or more tracks of the CMAF switching set; and generating a bitstream based on the determining.

11. A method for storing bitstream of a video comprising: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are present in one or more tracks of the CMAF switching set; generating a bitstream based on the determining; and storing the bitstream in a non-transitory computer-readable recording medium.

12. A method, apparatus or system described in the present document.

Additional solutions show examples of techniques discussed herein.

1. A method for processing media data comprising: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are allowed to be present in one or more tracks of the CMAF switching set; and performing a conversion between a media data and a media data file based on the indication.

2. The method of solution 1, wherein the indication is an EDRAP allowed flag (edrap_allowed_flag), and wherein the edrap_allowed_flag specifies whether EDRAP samples may be present in one or more tracks indexed in the ARI track.

3. The method of any of solutions 1-2, wherein an EDRAP sample is a sample for which all subsequent samples in a same track in both decoding and output order can be correctly decoded provided that a closest preceding sequence access point (SAP) sample of type 1, 2, or 3 and zero or more preceding EDRAP samples are available when decoding the sample and subsequent samples.

4. The method of any of solutions 1-3, wherein the edrap_allowed_flag is included in CMAF addressable resource index metadata.

5. The method of any of solutions 1-4, wherein the ARI track includes a SAP is an EDRAP flag (sap_is_edrap_flag) that indicates whether the SAP chunk starts with is an EDRAP.

6. The method of any of solutions 1-5, wherein a value of sap_is_edrap_flag shall be equal to 0 when edrap_allowed_flag is equal to 0.

7. The method of any of solutions 1-6, wherein the sap_is_edrap_flag is included in a CMAF addressable resource index sample.

8. The method of any of solutions 1-7, wherein the ARI track includes a SAP type (SAP_type), and wherein the SAP_type, when greater than 0, identifies the SAP type of a SAP a chunk starts with.

9. The method of any of solutions 1-8, wherein the SAP_type is included in a CMAF addressable resource index sample.

10. The method of any of solutions 1-9, wherein the conversion comprises generating the media data file from the media data.

11. The method of any of solutions 1-9, wherein the conversion comprises parsing the media data from the media data file.

12. A non-transitory computer-readable recording medium storing a bitstream of a video which is generated by a method performed by a video processing apparatus, wherein the method comprises: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are allowed to be present in one or more tracks of the CMAF switching set; and generating a bitstream based on the determining.

13. The non-transitory computer-readable recording medium of solution 12, wherein the indication is an EDRAP allowed flag (edrap_allowed_flag), and wherein the edrap_allowed_flag specifies whether EDRAP samples may be present in one or more tracks indexed in the ARI track.

14. The non-transitory computer-readable recording medium of any of solutions 12-13, wherein an EDRAP sample is a sample for which all subsequent samples in a same track in both decoding and output order can be correctly decoded provided that a closest preceding sequence access point (SAP) sample of type 1, 2, or 3 and zero or more preceding EDRAP samples are available when decoding the sample and subsequent samples.

15. The non-transitory computer-readable recording medium of any of solutions 12-14, wherein the edrap_allowed_flag is included in CMAF addressable resource index metadata.

16. The non-transitory computer-readable recording medium of any of solutions 12-15, wherein the ARI track includes a SAP is an EDRAP flag (sap_is_edrap_flag) that indicates whether the SAP chunk starts with is an EDRAP.

17. The non-transitory computer-readable recording medium of any of solutions 12-16, wherein a value of sap_is_edrap_flag shall be equal to 0 when edrap_allowed_flag is equal to 0.

18. The non-transitory computer-readable recording medium of any of solutions 12-17, wherein the sap_is_edrap_flag is included in a CMAF addressable resource index sample.

19. The non-transitory computer-readable recording medium of any of solutions 12-18, wherein the ARI track includes a SAP type (SAP_type), and wherein the SAP_type, when greater than 0, identifies the SAP type of a SAP a chunk starts with.

20. The non-transitory computer-readable recording medium of any of solutions 12-19, wherein the SAP_type is included in a CMAF addressable resource index sample.

21. An apparatus for processing video data comprising: at least one processor; and a non-transitory memory with instructions thereon, wherein the instructions upon execution by the at least one processor, cause the at least one processor to perform the method of any of solutions 1-11.

22. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-11.

23. A method for storing bitstream of a video comprising: determining an indication in an Addressable Resource Index (ARI) track configuration box in an ARI track, wherein the ARI track indexes a Common Media Application Format (CMAF) switching set, and wherein the indication indicates whether extended dependent random access point (EDRAP) samples are allowed to be present in one or more tracks of the CMAF switching set; generating a bitstream based on the determining; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining a first syntax element in an addressable resource index (ARI) track configuration box for an ARI track, wherein the ARI track is applied to a common media application format (CMAF) switching set, and wherein the first syntax element indicates whether extended dependent random access point (EDRAP) samples are allowed to be present in one or more tracks indexed in the ARI track; and
performing a conversion between media data and a media data file based on the determining.

2. The method of claim 1, wherein the first syntax element is coded using an unsigned integer with one bit.

3. The method of claim 1, wherein the EDRAP sample is a sample for which all subsequent samples in a same track in both decoding and output order can be correctly decoded provided that a closest preceding sequence access point (SAP) sample of type 1, 2, or 3 and zero or more preceding EDRAP samples are available when decoding the sample and subsequent samples.

4. The method of claim 1, wherein the method further comprises:
determining a second syntax element in an ARI track format structure for the ARI track, wherein the second syntax element indicates whether a sequence access point (SAP) a CMAF chunk starts with is an EDRAP.

5. The method of claim 4, wherein, in response to a value of the first syntax element being equal to 0, a value of the second syntax element is equal to 0.

6. The method of claim 4, wherein the second syntax element is coded using an unsigned integer with one bit.

7. The method of claim 1, wherein the method further comprises:
determining a third syntax element in an ARI track format structure for the ARI track, wherein the third syntax element, when greater than 0, identifies a sequence access point (SAP) type of a sample a CMAF chunk starts with.

8. The method of claim 1, wherein the ARI track configuration box comprises a fourth syntax element which indicates a number of tracks indexed in the ARI track, and the fourth syntax is coded using an unsigned integer with ten bits.

9. The method of claim 1, wherein the ARI track configuration box comprises a fifth syntax element which specifies a number of quality indicators used for identifying quality of a CMAF chunk, and the fifth syntax is coded using an unsigned integer with ten bits.

10. The method of claim 1, wherein the conversion comprises generating the media data file from the media data.

11. The method of claim 1, wherein the conversion comprises parsing the media data from the media data file.

12. An apparatus for processing media data comprising: a processor; and a non-transitory memory with instructions thereon, wherein the instructions upon execution by the processor, cause the processor to:
determine a first syntax element in an addressable resource index (ARI) track configuration box for an ARI track, wherein the ARI track is applied to a common media application format (CMAF) switching set, and wherein the first syntax element indicates whether extended dependent random access point (EDRAP) samples are allowed to be present in one or more tracks indexed in the ARI track; and
perform a conversion between media data and a media data file based on the determining.

13. The apparatus of claim 12, wherein the first syntax element is coded using an unsigned integer with one bit.

14. The apparatus of claim 12, wherein the EDRAP sample is a sample for which all subsequent samples in a same track in both decoding and output order can be correctly decoded provided that a closest preceding sequence access point (SAP) sample of type 1, 2, or 3 and zero or more preceding EDRAP samples are available when decoding the sample and subsequent samples.

15. A non-transitory computer-readable storage medium storing instructions that cause a processor to:
determine a first syntax element in an addressable resource index (ARI) track configuration box for an ARI track, wherein the ARI track is applied to a common media application format (CMAF) switching set, and wherein the first syntax element indicates whether extended dependent random access point (EDRAP) samples are allowed to be present in one or more tracks indexed in the ARI track; and
perform a conversion between media data and a media data file based on the determining.

16. The non-transitory computer-readable storage medium of claim 15, wherein the first syntax element is coded using an unsigned integer with one bit.

17. The non-transitory computer-readable storage medium of claim 15, wherein the EDRAP sample is a sample for which all subsequent samples in a same track in both decoding and output order can be correctly decoded provided that a closest preceding sequence access point (SAP) sample of type 1, 2, or 3 and zero or more preceding EDRAP samples are available when decoding the sample and subsequent samples.

18. A non-transitory computer-readable recording medium storing a media data file which is generated by a method performed by a video processing apparatus, wherein the method comprises:
determining a first syntax element in an addressable resource index (ARI) track configuration box for an ARI track, wherein the ARI track is applied to a common media application format (CMAF) switching set, and wherein the first syntax element indicates whether extended dependent random access point (EDRAP) samples are allowed to be present in one or more tracks indexed in the ARI track; and
generating the media data file based on the determining.

19. The non-transitory computer-readable recording medium of claim 18, wherein the first syntax element is coded using an unsigned integer with one bit.

20. The non-transitory computer-readable recording medium of claim 18, wherein the EDRAP sample is a sample for which all subsequent samples in a same track in both decoding and output order can be correctly decoded provided that a closest preceding sequence access point (SAP) sample of type 1, 2, or 3 and zero or more preceding EDRAP samples are available when decoding the sample and subsequent samples.
